(19) United States
(12) Patent Application Publication
(10) Pub. No.: US 2024/0335817 A1
(43) Pub. Date: Oct. 10, 2024

(54) METHOD TO PREPARE CROSS-LINKED, SURFACE FUNCTIONALIZED POLYSTYRENE DIVINYLBENZENE BEADS

(71) Applicant: CLIMEWORKS AG, Zürich (CH)

(72) Inventors: Visuta ENGKAGUL, Zürich (CH); Baptiste MONNEY, Zürich (CH); José Augusto BERROCAL, Zürich (CH); Christoph WEDER, Zürich (CH); Angelo VARGAS, Zürich (CH); Davide ALBANI, Zürich (CH); Claudio LIMONE, Zürich (CH)

(73) Assignee: CLIMEWORKS AG, Zürich (CH)

(21) Appl. No.: 18/716,333

(22) PCT Filed: Dec. 2, 2022
(86) PCT No.: PCT/EP2022/084193

§ 371 Date: Jun. 4, 2024

(30) Foreign Application Priority Data
Dec. 9, 2021 (EP) 21213417.5

(51) Int. Cl. B01J 20/26; B01D 53/04; B01D 53/047; B01J 20/28; B01J 20/34; C08F 8/30

(52) U.S. Cl. CPC B01J 20/267; B01D 53/04; B01D 53/0462; B01D 53/0476; B01J 20/28004; B01J 20/28019; B01J 20/28059; B01J 20/28061; B01J 20/3425; B01J 20/3466; C08F 8/30; B01D 2253/202; B01D 2253/25; B01D 2253/304; B01D 2253/306; B01D 2253/34; B01D 2257/504; B01D 2258/0283; B01D 2258/05; B01D 2258/06; B01D 2259/4009

(57) ABSTRACT

Method for the preparation of a sorbent material and for use of such a material for separating gaseous carbon dioxide from a gas mixture, preferably for direct air capture, using a temperature, vacuum, or temperature/vacuum swing process, comprising primary amine moieties immobilized on a solid support, wherein the primary amine moieties, in the α-carbon position, are substituted by one hydrogen and one non-hydrogen substituent, wherein the sorbent material is in the form of a monolith, a layer, fibres, or particles, wherein the non-hydrogen substituent is selected from the group consisting of alkyl, alkenyl, arylalkyl, and wherein the solid support of the sorbent material is a porous material. Starting from a precursor of said sorbent material comprising one or multiple keto-groups, said one or multiple keto groups are converted into said primary amine moieties through a reductive amination.

### TECHNICAL FIELD

The present invention relates to a method to prepare cross-linked polystyrene divinylbenzene beads functionalized with alpha alkyl benzylamino moieties using a 2-step synthesis in particular for use as CO2 capture material, as well as to corresponding direct air capture processes.

### PRIOR ART

According to the OECD report of 2017 [Global Energy & CO₂ Status Report 2017, OECD/IEA March 2018] the yearly emissions of CO₂ into the atmosphere are ca 32.5 Gt (Gigatons, or 3×10⁹ tons). As of February 2020 all but two of the 196 states that in 2016 have negotiated the Paris Agreement within the United Nations Framework Convention on Climate Change (UFCCC) have ratified it. The meaning of this figure is that a consensus is reached regarding the threat of climate change and regarding the need of a global response to keep the rise of global temperature well below 2 degrees Celsius above pre-industrial levels.

The technical and scientific community engaged in the challenge of proposing solutions to meet the target of limiting CO₂ emissions to the atmosphere and to remove greenhouse gases from the atmosphere has envisioned a number of technologies. Flue gas capture, or the capture of CO₂ from point sources, such as specific industrial processes and specific CO₂ emitters, deals with a wide range of relatively high concentrations of CO₂ (3-100 vol %) depending on the process that produces the flue gas. High concentrations make the separation of the CO₂ from other gases thermodynamically more favorable and consequently economically favorable as compared to the separation of CO₂ from sources with lower concentrations, such as ambient air, where the concentration is in the order of 400 ppmv. Nonetheless, the very concept of capturing CO₂ from point sources has strong limitations: it is specifically suitable to target such point sources, but is inherently linked to specific locations where the point sources are located and can at best limit emissions and support reaching carbon neutrality, while as a technical solution it will not be able to contribute to negative emissions (i.e., permanent removal of carbon dioxide from the atmosphere) and to remove emission from the past. In order to achieve negative emissions (i.e., permanent removal carbon dioxide from the atmosphere), the two most notable solutions currently applied, albeit being at an early stage of development, are the capturing of CO₂ by means of vegetation (i.e., trees and plants, but not really permanent removal) using natural photosynthesis, and by means of direct air capture (DAC) technologies, which is the only really permanent removal.

Forestation has broad resonance with the public opinion. However, the scope and feasibility of re-forestation projects is debated and is likely to be less simple an approach as believed because it requires a large footprint in terms of occupied surface to captured CO₂ ratio. On the other hand, DAC has lower land footprint and therefore it does not compete with the production of crops, can permanently remove CO₂ from the atmosphere and can be deployed everywhere on the planet.

The above-described strategies to mitigate climate change all have potential and are considered as a potential part of the overall solution. The most likely future scenario is the deployment of a mix of such approaches, after undergoing further development.

Several DAC technologies were described in expert literature, such as for example, the utilization of alkaline earth oxides to form calcium carbonate as described in US-A-2010034724. Different approaches comprise the utilization of solid CO₂ adsorbents, hereafter named sorbents, in the form of packed beds of typically sorbent particles and where CO₂ is captured at the gas-solid interface. Such sorbents can contain different types of amino functionalization and polymers, such as immobilized aminosilane-based sorbents as reported in U.S. Pat. No. 8,834,822, and amine-functionalized cellulose as disclosed in WO-A-2012/168346.

WO-A-2011/049759 describes the utilization of an ion exchange material comprising an aminoalkylated bead polymer for the removal of carbon dioxide from industrial applications. WO-A-2016/037668 describes a sorbent for reversibly adsorbing CO₂ from a gas mixture, where the sorbent is composed of a polymeric adsorbent having a primary amino functionality. The materials can be regenerated by applying a pressure or humidity swing.

Several academic publications, such as Alesi et al. in Industrial & Engineering Chemistry Research 2012, 51, 6907-6915; Veneman et al. in Energy Procedia 2014, 63, 2336; Yu et al. in Industrial & Engineering Chemistry Research 2017, 56, 3259-3269, also investigated in detail the use of cross-linked polystyrene resins functionalized with primary benzyl-amines as solid sorbents for DAC applications.

The state-of-the-art technology to capture CO₂ from point sources typically uses liquid amines, as for example in industrial scrubbers, where the flue gas flows into a solution of an amine (U.S. Pat. No. 9,186,617). Other technologies are based on the use of solid sorbents in either a packed-bed or a flow-through structure configuration, where the sorbent is made of impregnated or covalently bound amines onto a support.

Amines react with CO₂ to form a carbamate moiety, which in a successive step can be regenerated to the original amine, for example by increasing the temperature of the sorbent bed to ca 100° C. and therefore releasing the CO₂. An economically viable process for carbon capture implies the ability to perform the cyclic adsorption/desorption of CO₂ for hundreds or thousands of cycles with the same sorbent material, where the sorbent shall not undergo significant chemical transformations that impedes its reactivity towards CO₂.

XU HUI et al in: “Preparation of anion exchangers by reductive amination of acetylated crosslinked polystyrene”, REACTIVE AND FUNCTIONAL POLYMERS, vol. 42, no. 3, 24 Nov. 1999, pages 235-242 reports on a novel method for preparing anion exchangers based on crosslinked polystyrene by reductive amination of acetylated copolymers. This method avoids the use of carcinogenic chloromethylmethylether (CME) or bis-chloromethyl ether (BCME) which is broadly used by the classic chloromethylation process, and meanwhile overcomes additional crosslinking, which is disadvantageous to the resins. The reactions involving Friedel-Crafts acetylation and reductive amination are mild and easily processed, which is beneficial for the new method to be used practically and probably also to be applied in industry. The reactions were investigated in an attempt to find conditions under which the best results could be achieved, and resulting products were analysed by FTIR spectra. The exchange capacity and water content of the derived resins were also examined.

ZATIRAKHA et al. in: “Synthesis and chromatographic properties of new polymer-based anion exchangers”, MOSCOW UNIVERSITY CHEMISTRY BULLETIN, ALLERTON PRESS, INC, HEIDELBERG, vol. 66, no. 3, 4 Aug. 2011, pages 161-165, present new anion exchangers with the trimethylammonium functional group were prepared as a result of three-step synthesis involving the acylation of styrene-divinylbenzene copolymer with 25% cross-linking, the reductive amination of carbonyl groups, and subsequent methylation. Two methods of reductive amination were studied, and optimal conditions for this process were chosen. Chromatographic properties of the adsorbents were examined in a mode of ion chromatography with suppressed background conductivity and conductometric detection. The obtained anion exchangers demonstrated good selectivity, and the maximum efficiency was 30000 TP/m.

WO-A-2016038339 relates to a process for removing carbon dioxide from a mixture of gases, and to a process for reducing the partial pressure of carbon dioxide in an enclosed space. The processes of the presented invention employ a carbon dioxide adsorbent comprising benzyl amine moieties immobilised on a solid support. The process comprises regenerating the adsorbent by heating to a temperature in the range from 40° C. to 75° C. US-A-2012076711 discloses a structure containing a sorbent with amine groups that is capable of a reversible adsorption and desorption cycle for capturing CO₂ from a gas mixture wherein said structure is composed of fiber filaments wherein the fiber material is carbon and/or polyacrylonitrile.

### SUMMARY OF THE INVENTION

An economically viable process for carbon capture implies the ability to perform the cyclic adsorption/desorption of CO₂ for hundreds or thousands of cycles over the same sorbent material, where the sorbent shall not undergo significant chemical transformations that impedes its reactivity towards CO₂. Adsorption and desorption cycles of CO₂ capture from a gas stream occur in the presence of varying amount of oxygen, and in particular desorption cycles involve a temperature swing, where the sorbent bed is heated to a temperature in the range of 100° C. Under such conditions, amines can react with oxygen to form adducts and this generally lowers the amine adsorbing capability of the sorbent.

Those major products of amine oxidative degradation, namely amide and/or imine functionalities, are suspected to be formed by a mechanism that involves as first event the hydrogen abstraction from the α carbon (definition see below). The resulting oxidized species in the form of amides and/or imines lose their ability to bind CO₂.

During a carbon capture process, this is not likely to happen all at once. During multiple cycles, the oxidized species accumulate at the expense of the amines. The amines continue to react with CO₂, but their number decreases with time as they are transformed into amides and/or imines or other species. This is associated with a degradation process of the CO₂ capturing material because the sorbent gradually decreases its capacity to capture CO₂ from the gas stream.

When this happens to such an extent that the cost of running the process does not balance the benefit of CO₂ extraction, the sorbent material must be exchanged with fresh material. Before describing the invention, the notation that will be used in the following shall be defined. According to IUPAC nomenclature, the position of the carbon to which the amine is bound is indicated as C(1), or position 1. In a non-IUPAC nomenclature, but often used notation, the same carbon is indicated as the alpha carbon, or α-carbon. If multiple amines groups are present on the alkyl chain the IUPAC numbering can change, since such numbering relates to the whole molecule, rather than to a single group, and will change according to the IUPAC rules of priority. In such cases the α-carbon to an amine is not necessarily the C(1). Since when there are multiple amines on an alkyl chain the numbering notation according to IUPAC allows for different numbering of the atoms to which the N is bound, for the present purpose the use of the α-carbon nomenclature is more consistent and will be used.

The term primary amines is used here to designate amines that have one single alkyl (or aryl or alkyl-aryl) substituent bonded to the nitrogen atom, while the rest of substituents is hydrogen. The term secondary amines is used here to designate amines with two alkyl (or aryl) substituents bonded to the nitrogen atom, while one substituent is a hydrogen atom.

Oxidative degradation of primary and secondary amine-based solid sorbents is thought to involve hydrogen abstraction from the α-carbon to the amine functionality and to the formation of e.g. an amide. The major products of amine oxidative degradation are exemplified above. Hence, to form an amide or imine, the position of attack of the oxygen occurs at the α-carbon to the amine functionality, resulting in the loss of ability of the nitrogen atom to bind CO₂ and required the α-carbon to be substituted with at least one hydrogen. To overcome these problems it is possible to use primary or secondary amino-based sorbents, preferably polymeric sorbent substrate based, for separating gaseous carbon dioxide from a mixture in a cyclic manner, preferably from at least one of ambient air, flue gas and biogas, in particular to DAC methods, having primary amine moieties that are substituted at the α-carbon with one single substituent different from hydrogen, so having only one single hydrogen at the α-carbon and/or having secondary amine moieties that are substituted at least one or preferably both the α-carbons with one single substituent different from hydrogen. This approach has been described in EP 20 186 310.7, which is included by reference.

The present invention relates to a new 2-step synthesis of cross-linked poly(styrene-co-divinylbenzene) (PS) beads for CO₂ capture functionalized in particular with α-methylbenzylamino moieties (herein referred to as α-methyl-benzyl-amino modified PS beads), whose chemical structure is shown in FIG. 1a, as well as to a use of such a material for separating gaseous carbon dioxide from a gas mixture, i.e. a method for separating gaseous carbon dioxide from a gas mixture, preferably from at least one of ambient atmospheric air, flue gas and biogas, preferably for direct air capture, in particular and preferably using a temperature, vacuum, or temperature/vacuum swing process.

The synthetic accessibility of such a product was previously accomplished through a synthetic strategy comprising 5 consecutive reaction steps, as has been described in EP 20 186 310.7, which is included by reference as concerns this aspect of synthesis. To make the process more appropriate for upscaling and industrial use, we explored multiple synthetic approaches to shorten the route to only two synthetic steps. The key synthetic intermediate of our approach is the acetophenone-modified polystyrenedivinylbenzene (hereafter denoted as PS ketone, see FIG. 1b). Notwithstanding the reactions used in those attempts are well-known to the skilled person in organic chemistry and used for the synthesis of small molecules, surprisingly these reactions have never been applied to a polymer in heterogeneous phase in particular not for the proposed use. This invention relates to the development of a truly suitable 2-step synthesis from the acetophenone-modified polystyrenedivinylbenzene to the corresponding primary amine that work on substrates that are insoluble to the reaction media and in particular to use such a material for separating gaseous carbon dioxide from a gas mixture, i.e. for a method for separating gaseous carbon dioxide from a gas mixture, preferably from at least one of ambient atmospheric air, flue gas and biogas, preferably for direct air capture, preferably using a temperature, vacuum, or temperature/vacuum swing process.

We initially opted for three synthetic routes: Leuckart reaction (FIG. 2a, see e.g. A. W. Ingersoll α-Phenylethylamine. Org. Synth. 1937, 17, 76), a variant of the Gabriel amine synthesis using tosylhydrazone as alkylating reagent (FIG. 2b, see e.g. A. K. Yadav; L. D. S. Yadav, An unprecedented approach to the Gabriel amine synthesis utilizing tosylhydrazones as alkylating agents RSC Adv. 2014, 4, 34764-34767), and a reductive amination procedure involving ammonium acetate and cyano borohydride (FIG. 2c, see e.g. Dong, L.; Aleem, S.; Fink, C. A. Microwave-accelerated reductive amination between ketones and ammonium acetate. Tetrahedron Lett. 2010, 51, 5210-5212).

We first attempted the ketone→α-methylbenzylamino conversion of PS ketone by adapting the literature conditions of the Leuckart reaction (FIG. 3). This reaction involves the formation of the formamide intermediate, whose appearance can be confirmed by the peaks at 1665 cm⁻¹ and 3290 cm⁻¹, which are assigned to the C═O and N—H vibrations observed in the infrared spectrum (FIG. 4). The skilled person in organic chemistry is well aware that the formamide intermediate should lead to the amino group upon exposure to an acidic solution. Surprisingly, we were not able to convert the formamide intermediate by exposing the polymer to concentrated HCl at room temperature for one hour, and even at 110° C. overnight, since there was no significant decrease of the intensity of the peaks ascribed to the formamide intermediate. This approach, which is outside of the present invention, provides striking evidence that well-known reactions for small molecules do not normally work for substrates in heterogeneous phases.

The second synthetic strategy that we explored for the production of the desired product, which is also outside of the present invention, was a variant of the Gabriel amine synthesis, in which para-toluenesulfonylhydrazone (p-tosylhydrazone) is used as alkylating reagent (schematically shown in Scheme 1b in FIG. 2 for acetophenone). According to the reaction mechanism suggested by literature reports, the first reaction intermediate is the p-tosylhydrazone formed by the condensation between the ketone and para-toluenesulfonylhydrazone (p-tosylhydrazide) reagent. This intermediate, under basic conditions, undergoes the thermal elimination of N₂ and the p-tosyl group, generating a copper (I) carbene that inserts into the N—H bond of the phthalimide and thereby creates a stable alkylated phthalimide-derivative. The hydrolysis of this species by hydrazine then affords the target product. The reaction conditions that were applied for the attempted conversion of PS ketone are shown in FIG. 5a. Our initial attempts focused on adapting the one-pot reaction sequence (total of 3 steps combined in one) used previously for small molecules (FIG. 1b) to PS ketone. Surprisingly, contrarily to what described in the literature for small molecules, the FT-IR spectra of the crude products of these attempts always matched with the one of PS ketone, indicating that no substantial reaction of PS ketone was achieved.

Without being bound to any theoretical explanation, we believe that using heterogeneous substrates with an internal porous structure can lead to diffusion and accessibility problems because the reactants have to reach the sites and the transition state may be hindered due to the three-dimensional structure of the porous solid.

The third approach we used is the reductive amination of PS ketone. Three different heating conditions were used, namely microwave heating (hereafter denoted as “microwave”), conventional heating in a sealed round bottom flask (silicone oil bath; hereafter denoted as “hotplate”), and heating in an autoclave (hereafter referred to as “autoclave 1”). The modification of the reaction conditions with respect to previously published procedures was necessary in view of the cross-linked nature of the functionalized polystyrenedivinylbenzene polymer, i.e., the PS ketone, which is not soluble in the reaction medium. The outcome of the three reactions was again monitored by FT-IR spectroscopy. Diagnostic signals for monitoring the ketone-amine conversion are the N—H stretching vibrations (broad signal around 3600 and 3000 cm⁻¹) and the sharp and intense C═O vibration at 1680 cm⁻¹, which are the selected regions of the FT-IR spectra shown in FIG. 6. To confirm if the broad peak at 3300 cm⁻¹ in the FT-IR spectrum is indeed associated with N—H stretching vibrations, and not related to energetically similar O—H stretching vibrations resulting from a reduction of the ketone moieties into alcohol groups, we performed a control reaction (control microwave 1) under the same microwave conditions, but without ammonium acetate. The choice to perform this control reaction under microwave irradiation instead of autoclave conditions was based on the shorter reaction times necessary with this heating method. Gratifyingly, the spectrum of the crude product of control microwave 1 is superimposable to the spectrum of starting PS ketone, and no signal around 3300 cm⁻¹ is seen (FIG. 6). Hence, the control reaction afforded unreacted starting material, suggesting that cyano borohydride is not a sufficiently strong reducing agent to allow the ketone-alcohol conversion.

To our surprise, in particular the reaction conducted in autoclave gave a quantitative conversion by showing a disappearance of the peak at 1680 cm⁻¹ and the appearance of the peak ascribed to the N—H stretching vibrations. The fact that the reaction in the autoclave is the only one that gave quantitative conversion to the final product may be ascribed to the finding that harsher reaction conditions are needed to be able to exploit chemistries known for small molecules and apply it to solid substrates with porosity.

In view of the above, the present invention relates to a method for the preparation of a sorbent material as claimed.

More specifically, it relates to a method for the preparation of a sorbent material comprising primary amine moieties immobilized on a solid support, wherein the primary amine moieties, in the α-carbon position, are substituted by one hydrogen and one non-hydrogen substituent (R). Evidently, due to the terminology, the α-carbon position stands for the chain connecting the primary amine moieties to the solid support, in particular to aromatic ring moieties of the solid support, on which they are immobilised, otherwise there would be no α-carbon position. In fact, according to common general knowledge, in organic chemistry, the alpha carbon (Cα) refers to the first carbon atom that attaches to a functional group, such as a in this case the amine moiety. The second carbon atom is called the beta carbon (Cβ), and the naming system continues in Greek alphabetical order. The nomenclature can also be applied to the hydrogen atoms attached to the carbon atoms. A hydrogen atom attached to an alpha carbon atom is called an alpha-hydrogen atom, a hydrogen atom on the beta-carbon atom is a beta hydrogen atom, and so on. This terminology necessarily implies that there is a chain, so at the α-carbon position there is always a chemical bond to the functional group and chemical bond to a further carbon atom or heteroatom in the chain. A α-carbon position therefore can only be substituted, using this terminology, by two substituents.

So in the α-carbon position here there is the inter-atom chemical bond of the α-carbon position, typically a C—C chemical bond, linking the carbon atom at the α-carbon position to the solid support, in particular to aromatic ring moieties of the solid support, and there is the chemical bond of the carbon atom at the α-carbon position to the primary amine. When talking about substitution at the α-carbon position this means the remaining two chemical bonds at the carbon atom of this α-carbon position (sp³ hybridisation), and this substitution is given by one hydrogen and one non-hydrogen substituent (R).

According to the invention, the sorbent material normally is in the form of a monolith, in the form of a layer or a plurality of layers, the form of hollow or solid fibres, including in woven or nonwoven (layer) structures, or the form of hollow or solid particles.

The non-hydrogen substituent (R) is normally selected from the group consisting of alkyl, alkenyl, arylalkyl.

Furthermore, normally the solid support of the sorbent material is a porous (solid) material based on an organic and/or inorganic material.

According to the invention, the method or the method for obtaining said sorbent material is carried out starting from a precursor of said sorbent material comprising one or multiple keto-groups, wherein said one or multiple keto-groups are converted into said primary amine moieties through a reductive amination, preferably with an ammonium salt and a cyanoborohydride salt.

According to a first preferred embodiment of this method for obtaining said sorbent material, it is carried out in that starting from said precursor sorbent material, which in in said α-carbon position carries a keto-group, this keto-group is converted into said primary amine moiety in said reductive amination, preferably with an ammonium salt and a cyanoborohydride salt.

Preferably, the non-hydrogen substituent (R) is selected from the group of methyl or ethyl, wherein preferably the non-hydrogen substituent (R) is the same for essentially all primary and/or secondary amine moieties and is selected as methyl.

The sorbent material is preferably a porous polymer material, selected from the group of linear or branched, cross-linked or uncross-linked polystyrene, polyethylene, polypropylene, polyamide, polyurethane, acrylate or methacrylate-based polymer including PMMA, or combinations thereof, wherein preferably the polymer material is poly(styrene) or poly(styrene-co-divinylbenzene) based, cellulose, or an inorganic material including silica, alumina, activated carbon, and combinations thereof.

Most preferably, the sorbent material is a porous cross-linked polystyrene material and preferably poly(styrene-co-divinylbenzene), which is at least partially functionalized to or contains alkylbenzylamine moieties, preferably α-methylbenzylamine moieties, preferably throughout the material or at least or only on its surface.

Before or while carrying out the reductive amination, preferably the precursor sorbent material is swollen with a solvent, preferably with an organic solvent, preferably with an alcoholic solvent, most preferably with ethanol.

The ammonium salt for the reductive amination is preferably ammonium acetate.

The cyano borohydride salt preferred for the reductive amination is sodium cyano borohydride and/or potassium cyano borohydride.

According to yet another preferred embodiment, the reductive amination is carried out at elevated temperature, preferably above 50° C., more preferably above 80° C., and most preferably at a temperature in the range of 90-140° C.

Particularly preferably, for quantitative yield, the elevated temperature is established in an autoclave.

Typically, the elevated temperature is maintained for a time span of at least 1 hour, preferably at least 2 hours.

The reductive amination preferably involves two steps.

A first step of adding ammonium salt and a first portion of cyano borohydride salt, and a second step of adding the remaining cyano borohydride salt.

Preferably cyano borohydride is added in excess, and wherein, in case of the above two-step procedure, preferably the first portion makes up less than one equivalent or up to 1.5 equivalents, and the second remaining portion of cyano borohydride salt makes up another at least 1.5 or at least 2 equivalents, wherein most preferably in total more than three equivalents of cyano borohydride salt is added.

The method according to this invention is particularly suitable if the sorbent and/or the precursor sorbent material, in porous form, has a specific BET surface area, in the range of 0.5-100 m²/g or 1-50 m²/g or 1-40 m²/g, preferably 1-20 m²/g.

According to another preferred embodiment, the sorbent material and/or the precursor sorbent takes the form of preferably essentially spherical beads with a particle size (D50) in the range of 0.002-4 mm, 0.005-2 mm, 0.002-1.5 mm, 0.005-1.6 mm or 0.01-1.5 mm, preferably in the range of 0.30-1.25 mm.

Furthermore the present invention relates to a sorbent material obtained or obtainable using a method according to the method as described above.

Also the present invention relates to the use of such a sorbent material having a solid, preferably polymeric, support material functionalized on the surface with amino functionalities capable of reversibly binding carbon dioxide, for separating gaseous carbon dioxide from a gas mixture, preferably from at least one of ambient atmospheric air, flue gas and biogas, preferably for direct air capture, in particular using a temperature, vacuum, or temperature/vacuum swing process, wherein said sorbent material comprises primary amine moieties immobilized on a solid support, wherein the amine moieties, in the α-carbon position, are substituted by one hydrogen and one non-hydrogen substituent (R).

In other words, the present invention relates to a method for separating gaseous carbon dioxide from a gas mixture, preferably from at least one of ambient atmospheric air, flue gas and biogas, preferably for direct air capture, using a temperature, vacuum, or temperature/vacuum swing process, wherein said sorbent material comprises primary amine moieties immobilized on a solid support, wherein the amine moieties, in the α-carbon position, are substituted by one hydrogen and one non-hydrogen substituent (R).

Preferably the method is for separating gaseous carbon dioxide from a gas mixture, preferably from at least one of ambient atmospheric air, flue gas and biogas, containing said gaseous carbon dioxide as well as further gases different from gaseous carbon dioxide, by cyclic adsorption/desorption using a sorbent material adsorbing said gaseous carbon dioxide in a unit, wherein the method comprises at least the following sequential and in this sequence repeating steps (a)-(e):
(a) contacting said gas mixture with the sorbent material to allow at least said gaseous carbon dioxide to adsorb on the sorbent material by flow-through through said unit (8) under ambient atmospheric pressure conditions and ambient atmospheric temperature conditions in an adsorption step (if ambient atmospheric air is pushed through the device using a ventilator for the like, this is still considered ambient atmospheric pressure conditions in line with this application, even if the air which is pushed through the reactor by the ventilator has a pressure slightly above the surrounding ambient atmospheric pressure, and the pressures to is in the ranges as detailed above in the definition of “ambient atmospheric pressures”);
(b) isolating said sorbent material with adsorbed carbon dioxide in said unit from said flow-through;
(c) inducing an increase of the temperature of the sorbent material to a temperature starting the desorption of CO₂ (this is e.g. possible by injecting a stream of saturated or superheated steam by flow-through through the unit and thereby inducing an increase of the temperature of the sorbent material to a temperature between 6° and 110° C., starting the desorption of CO₂);
(d) extracting at least the desorbed gaseous carbon dioxide from the unit and separating gaseous carbon dioxide from steam in or downstream of the unit;
(e) bringing the sorbent material to ambient atmospheric temperature conditions (if the sorbent material is not cooled in this step down to exactly the surrounding ambient atmospheric temperature conditions, this is still considered to be according to this step, preferably the ambient atmospheric temperature established in this step (e) is in the range of the surrounding ambient atmospheric temperature +25° C., preferably +10° C. or +5° C.).

In the context of this disclosure, the expressions “ambient atmospheric pressure” and “ambient atmospheric temperature” refer to the pressure and temperature conditions to that a plant that is operated outdoors is exposed to, i.e. typically ambient atmospheric pressure stands for pressures in the range of 0.8 to 1.1 barabs and typically ambient atmospheric temperature refers to temperatures in the range of −40 to 60° C., more typically −30 to 45° C. The gas mixture used as input for the process is preferably ambient atmospheric air, i.e. air at ambient atmospheric pressure and at ambient atmospheric temperature, which normally implies a CO₂ concentration in the range of 0.03-0.06% by volume. However, also air with lower or higher CO₂ concentration can be used as input for the process, e.g. with a concentration of 0.1-0.5% by volume, so generally speaking, preferably the input CO₂ concentration of the input gas mixture is in the range of 0.01-0.5% by volume.

Further preferably, step (c) includes injecting a stream of saturated or superheated steam by flow-through through said unit.

Further preferably, step (b) involves isolating said sorbent material with adsorbed carbon dioxide in said unit from said flow-through while maintaining the temperature in the sorbent.

Further preferably, step (d) involves extracting at least the desorbed gaseous carbon dioxide from the unit and separating gaseous carbon dioxide from steam by condensation in or downstream of the unit.

Further preferably, step (c) involves inducing an increase of the temperature of the sorbent material to a temperature between 6° and 110° C., starting the desorption of CO₂.

Preferably, after step (d) and before step (e) the following step is carried out:
(d1) ceasing the injection and, if used, circulation of steam, and evacuation of the unit to pressure values between 20-500 mbar (abs), preferably in the range of 50-250 mbar (abs) in the unit, thereby causing evaporation of water from the sorbent and both drying and cooling the sorbent.

Step (e) is preferably carried out exclusively by contacting said ambient atmospheric air with the sorbent material under ambient atmospheric pressure conditions and ambient atmospheric temperature conditions to evaporate and carry away water in the unit and to bring the sorbent material to ambient atmospheric temperature conditions.

After step (b) and before step (c) the following step can be carried out:
(b1) flushing the unit of non-condensable gases by a stream of non-condensable steam while essentially holding the pressure of step (b), preferably holding the pressure of step (b) in a window of +50 mbar, preferably in a window of +20 mbar and/or holding the temperature below 75° C. or 70° C. or below 60° C., preferably below 50° C.

In a further embodiment of the step b1, the temperature of the adsorber structure rises from the conditions of step (a) to 80-110° C. preferably in the range of 95-105° C.

In step (b1) the unit can preferably be flushed with saturated steam or steam overheated by at most 20° C. in a ratio of 1 kg/h to 10 kg/h of steam per liter volume of the adsorber structure, while remaining at the pressure of step (b1), to purge the reactor of remaining gas mixture/ambient air. The purpose of removing this portion of ambient air is to improve the purity of the captured CO₂.

In step (c), steam can be injected in the form of steam introduced by way of a corresponding inlet of said unit, and steam can be (partly or completely) recirculated from an outlet of said unit to said inlet, preferably involving reheating of recirculated steam, or by the re-use of steam from a different reactor.

It should be noted that heating for desorption according to this process in step (c) is preferably only effected by this steam injection and there is no additional external or internal heating e.g. by way of tubing with a heat fluid.

In step (c) furthermore preferably the sorbent can be heated to a temperature in the range of 80-110° C. or 80-100° C., preferably to a temperature in the range of 85-98° C.
According to yet another preferred embodiment, in step (c) the pressure in the unit is in the range of 700-950 mbar (abs), preferably in the range of 750-900 mbar (abs).

Further preferably, the proposed method is for separating gaseous carbon dioxide from ambient atmospheric air.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows schematic structures of α-methyl-benzyl-amino modified PS beads and the corresponding ketone precursor in the extended (a) and compact (b) versions;

FIG. 2 shows a summary of protocols that in principle allow the transformation of small-molecule acetophenones under homogeneous reaction conditions into the corresponding α-methylbenzylamino derivatives;

FIG. 3 shows a scheme of synthesis of α-methylbenzylamino modified PS beads under heterogeneous Leuckart conditions;

FIG. 4 shows selected regions of the FT-IR spectra of starting PS ketone (black trace) and Leuckart PS (grey trace) beads;

FIG. 5 shows the attempted synthesis of α-methylbenzylamino modified PS beads through heterogeneous conditions via p-tosylhydrazide formation, divided into initial attempts and revised strategy; (b) chemical structure of commercially available compound 1, which was used as a reference small molecule;

FIG. 6 shows selected regions of the FT-IR spectra of starting PS ketone (short dashed trace), microwave 1 (long dashed trace), hotplate (dotted trace), autoclave 1 (thick solid trace), and control microwave 1 (thin solid trace) beads;

FIG. 7 shows a schematic representation of a direct air capture unit.

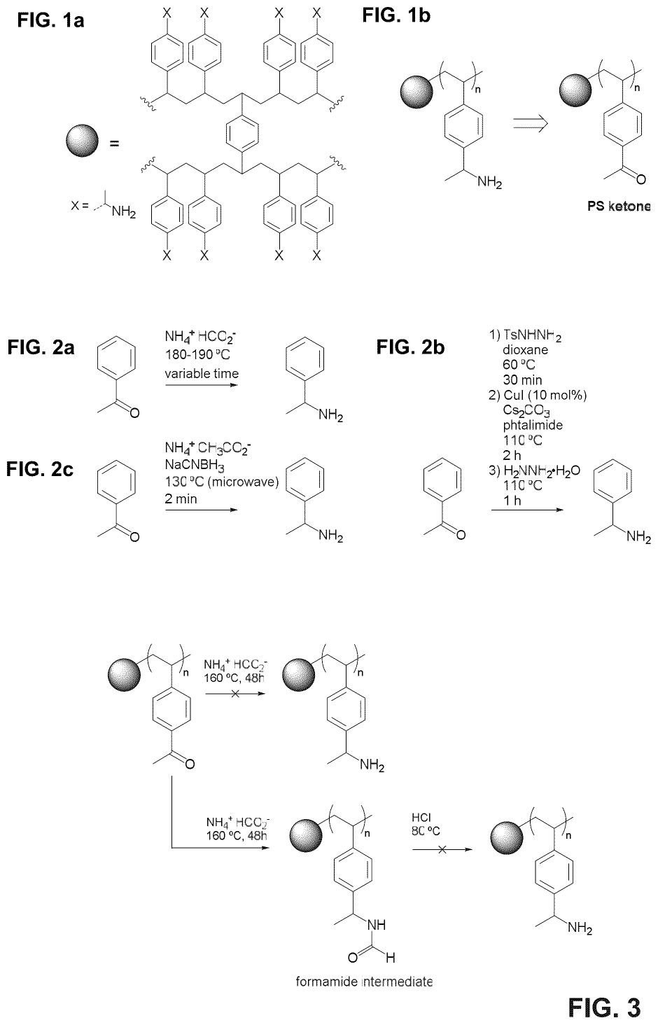

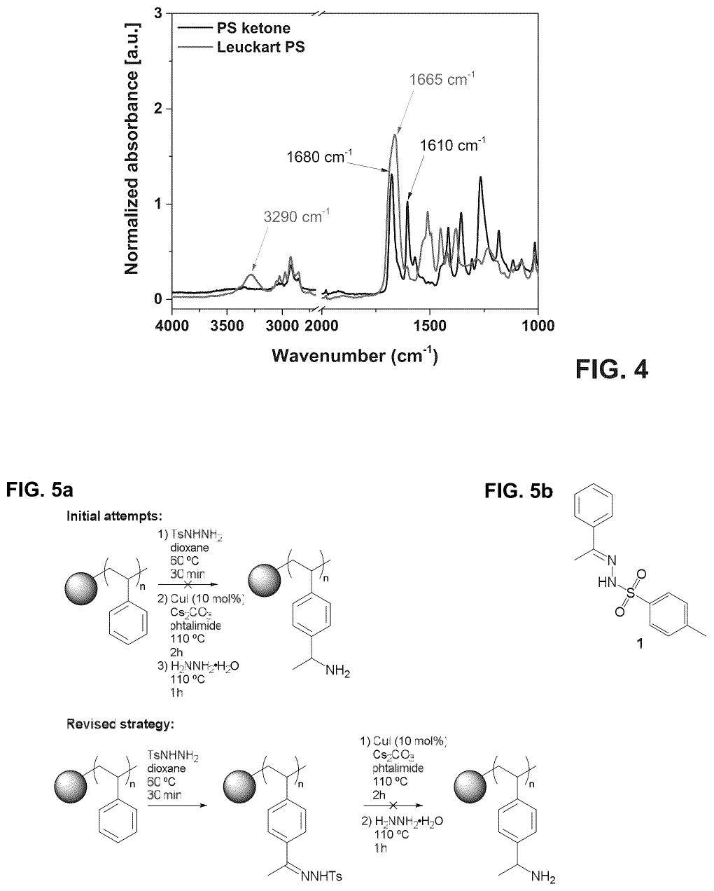

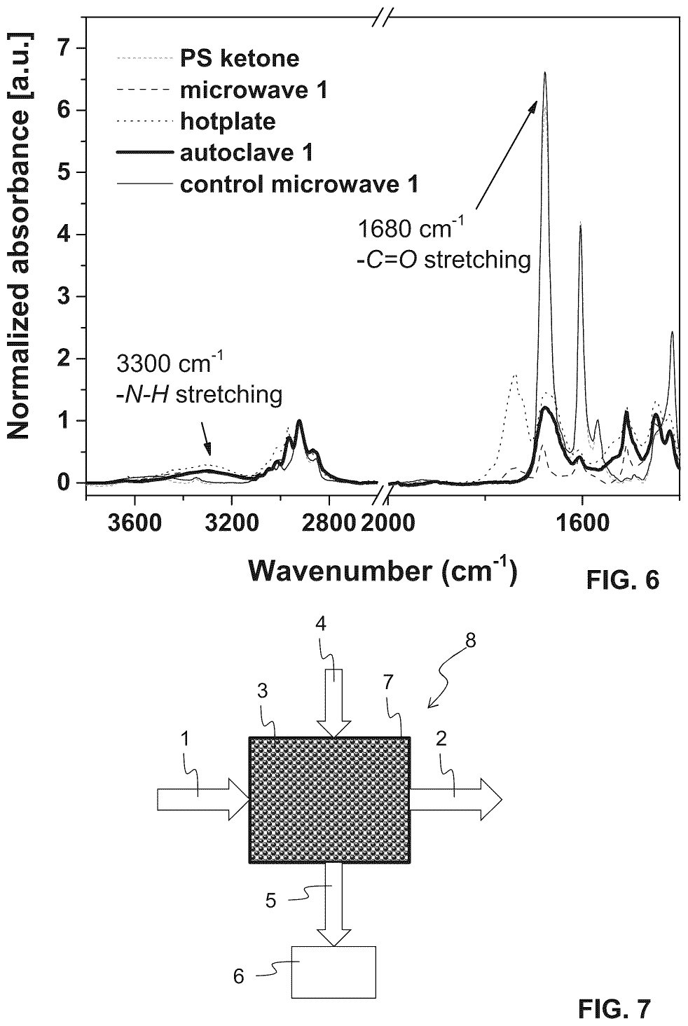

### DESCRIPTION OF PREFERRED EMBODIMENTS

### Experimental Procedures:

### PS Beads:

In a 1 L reactor, 1% (mass ratio) of gelatin and 2% (mass ratio) of sodium chloride are dissolved in 340 cm3 of water at 45° C. for 1 h. In another flask, 1 g of benzoyl peroxide is dissolved in a mixture of 57.8 g of styrene, 5.9 g of divinylbenzene (content 80%) and 63.8 g of C11-C13 iso-paraffin. The resulting mixture is then added to the reactor. After that the reaction mixture is stirred and heated up to 70° C. maintaining the temperature for 2 h, then the temperature is raised to 80° C. and kept it for 3 h, and then raised to 90° C. for 6 h. The reaction mixture is cooled down to room temperature and the beads are filtered off using a funnel glass filter and vacuum suction. The poly(styrene-co-divinylbenzene) beads are washed with toluene and dried in a rotavapor.

### PS Ketone:

20 g of poly(styrene-co-divinylbenzene) beads and 150 mL of 1,2-dichloroethane (DCE) were loaded into a reactor and stirred at room temperature (RT) for 5 minutes. To this suspension, 34.5 g of AlCl₃ was added. The resulting suspension was cooled to 0° C. A solution of 19.6 g acetyl chloride in 50 mL of 1,2-dichloroethane (DCE) was added dropwise to the reaction mixture. When the addition was complete, the suspension was stirred at 50° C. for 4 h. The reaction mixture was quenched with iso-propanol, and the acetylated PS beads thus made, an embodiment of a PS ketone (acetophenone-modified polystyrenedivinylbenzene), were filtered off, washed with water, 1 M aqueous HCl, water again (until pH≥5), and then dried.

### Exemplary Procedure for the Leuckart Reaction (Outside the Invention):

Ammonium formate (19.1 g, 0.3 mol) was loaded inside a 250 mL three-necked flask equipped with water condenser, under N₂ atmosphere. The temperature was raised to 160° C. to melt the solid while stirring. Acetophenone-modified polystyrenedivinylbenzene (in the following PS ketone) (1.5 g; 10 mmol) was added after ammonium formate had melted completely. The resulting mixture was heated at 160° C. for 24 hours. The reaction mixture was then cooled down, quenched with water, the beads were filtered off, added to 6 M hydrochloric acid (500 mL) and the mixture was heated under reflux conditions overnight at 110° C. After standing overnight, the so-obtained PS beads were filtered off and washed several times with water until the pH became neutral, and then with ethanol. The sample was dried under N₂ at 105° C.

Variant of the Gabriel Amine Synthesis; Optimized Procedure for the p-Tosylhydrazide Formation (Outside the Invention):

Prior to performing other operations, the PS ketone beads (2 g, 19.2 mmol) were placed in dioxane (50 mL) for 2 h to allow swelling. p-Toluenesulfonyl hydrazide (7.15 g, 38.4 mmol) was added in one portion to the suspension containing the swollen PS ketone beads. The resulting mixture was stirred and heated at 60° C. for 7 hours. The suspended beads were filtered off, and then washed with dioxane, chloroform, and n-heptane. The filtered beads were dried at 105° C. under a N₂ atmosphere.

### Reductive Amination Using Microwave:

Prior to performing other operations, the PS ketone beads (250 mg, 1.7 mmol) were placed in ethanol (5 mL) for 2 h to allow swelling inside a 20 mL microwave vial. Ammonium acetate (2.64 g, 34.2 mmol) and sodium cyanoborohydride (0.13 g, 2.1 mmol) were added in one portion to the suspension containing the swollen PS ketone beads. The microwave vial was sealed, and the resulting mixture was stirred and heated at 130° C. for 2 minutes in a microwave reactor. The suspended beads were filtered off, and then washed with ethanol, acetone, and n-pentane. The filtered beads were dried at 105° C. under a N₂ atmosphere.

### Reductive Amination Using Hotplate:

Prior to performing other operations, swelling of the PS ketone beads (250 mg, 1.7 mmol) in ethanol (5 mL) was carried out for 2 h inside a round bottom flask. Ammonium acetate (2.64 g, 34.2 mmol) and sodium cyanoborohydride (0.13 g, 2.1 mmol) were added in one portion to the suspension containing the swollen PS ketone beads inside the round bottom flask. The flask was sealed, and the resulting mixture was stirred and heated at 130° C. for 24 hours with a silicone oil bath. The suspended beads were filtered off, and then washed with ethanol, acetone, and n-pentane. The filtered beads were dried at 105° C. under a N₂ atmosphere.

### Reductive Amination Using Autoclave:

Reaction repeated on two different batches of 5 g of PS ketone beads. Prior to performing other operations, swelling of the PS ketone beads (5 g, 34.2 mmol) in ethanol (100 mL) was carried out for 2 h inside a glass beaker. Ammonium acetate (53 g, 688 mmol) and sodium cyanoborohydride (2.58 g, 41 mmol) were added in one portion to the suspension containing the swollen PS ketone beads. The glass beaker was introduced into the autoclave, which was sealed and placed on a hot plate kept at 130° C. for 24 hours. The suspended beads were filtered off, and then washed with ethanol, acetone, and n-pentane. The filtered beads were dried at 105° C. under a N₂ atmosphere.

### Carbon Dioxide Capture Properties:

The beads according to the above examples were tested in an experimental rig in which the beads were contained in a packed-bed reactor or in air permeable layers. The rig is schematically illustrated in FIG. 7. There is an ambient air inflow structure 1 and the actual reactor unit 8 comprises a container or wall 7 within which the layers of sorbent material 3 are located. There is an inflow structure 4 for desorption, if for example steam is used for desorption, and there is a reactor outlet 5 for extraction. Further, there is a vacuum unit 6 for evacuating the reactor.

For the adsorption measurements, 6 g of dry sample was filled into a cylinder with an inner diameter of 40 mm and a height of 40 mm and placed into a CO₂ adsorption/desorption device, where it was exposed to a flow of 2.0 NL/min of air at 30° C. containing 450 ppmv CO₂, having a relative humidity of 60% corresponding to a temperature of 30° C. for a duration of 600 min. Prior to adsorption, the sorbent bed was desorbed by heating the sorbent to 94° C. under an air flow of 2.0 NL/min. The amount of CO₂ adsorbed on the sorbent was determined by integration of the signal of an infrared sensor measuring the CO₂ content of the air stream leaving the cylinder.

The adsorber structure can alternatively be operated using a temperature/vacuum swing direct air capture process involving temperatures up to and vacuum pressures in the range of 50-250 mbar (abs) and heating the sorbent to a temperature between 6° and 110° C. In addition, experiments involving steam were carried out, with or without vacuum.

From the experiments one can see that the adsorption characteristics are reestablished after the regeneration process.

LIST OF REFERENCE SIGNS

| | |
|---|---|
| 1 | ambient air, ambient air |
| | inflow structure |
| 2 | outflow of ambient air behind |
| | adsorption unit in adsorption |
| | flow-through mode |
| 3 | sorbent material |
| 4 | steam, steam inflow structure |
| | for desorption |
| 5 | reactor outlet for extraction |
| 6 | vacuum unit/separator |
| 7 | wall |
| 8 | reactor unit |

1. A method for separating gaseous carbon dioxide from a gas mixture,
using a temperature, vacuum, or temperature/vacuum swing process, wherein said sorbent material comprises primary amine moieties immobilized on a solid support, wherein the amine moieties, in the α-carbon position, are substituted by one hydrogen and one non-hydrogen substituent
wherein the primary amine moieties, in the α-carbon position, are substituted by one hydrogen and one non-hydrogen substituent,
wherein the sorbent material is in the form of a monolith, in the form of a layer or a plurality of layers, the form of hollow or solid fibres, including in woven or nonwoven (layer) structures, or the form of hollow or solid particles,
wherein the non-hydrogen substituent is selected from the group consisting of alkyl, alkenyl, arylalkyl,
wherein the solid support of the sorbent material is a porous material based on an organic and/or inorganic material,
and wherein, for obtaining said sorbent material, starting from a precursor of said sorbent material comprising one or multiple keto-groups, said one or multiple keto groups are converted into said primary amine moieties through a reductive amination.

2. The method according to claim 1, wherein, starting from said precursor sorbent material which in said α-carbon position carries a keto-group, this keto-group is converted into said primary amine moiety in said reductive amination.

3. The method according to claim 1, wherein the non-hydrogen substituent is selected from the group of methyl or ethyl.

4. The method according to claim 1, wherein the sorbent material is a porous polymer material, selected from the group of linear or branched, cross-linked or uncross-linked polystyrene, polyethylene, polypropylene, polyamide, polyurethane, acrylate and/or methacrylate based polymer including PMMA, or combinations thereof.

5. The method according to claim 1, wherein the sorbent material is a porous cross-linked polystyrene material, which is at least partially functionalized to or contains alkylbenzylamine moieties.

6. The method according to claim 1, wherein before and/or while carrying out the reductive amination the precursor sorbent material is swollen with a solvent.

7. The method according to claim 1, wherein the reductive amination is carried out with an ammonium salt and a cyanoborohydride salt.

8. The method according to claim 1, wherein the reductive amination is carried out at elevated temperature above 50° C.

9. The method according to claim 8, wherein the elevated temperature is established in an autoclave
or wherein the elevated temperature is maintained for a time span of at least 1 hour, or at least 2 hours.

10. The method according to claim 1, wherein the reductive amination involves two steps, a first step of adding ammonium salt and a first portion of cyano borohydride salt, and a second step of adding the remaining cyano borohydride salt.

11. The method according to claim 1, wherein the sorbent material and/or the precursor sorbent material, in porous form, has a specific BET surface area, in the range of 0.5-100 m²/g or 1-50 m²/g, or 1-20 m²/g.

12. The method according to claim 1, wherein the sorbent material and/or the precursor sorbent material takes the form of beads with a particle size (D50) in the range of 0.002-4 mm, 0.005-2 mm, 0.002-1.5 mm, 0.005-1.6 mm or 0.01-1.5 mm, or in the range of 0.30-1.25 mm.

13. The method according to claim 1, wherein for separating gaseous carbon dioxide from a gas mixture, by cyclic adsorption/desorption using a sorbent material adsorbing said gaseous carbon dioxide in a unit,
wherein the method comprises at least the following sequential and in this sequence repeating steps (a)-(e):
(a) contacting said gas mixture with the sorbent material to allow at least said gaseous carbon dioxide to adsorb on the sorbent material by flow-through through said unit under ambient atmospheric pressure conditions and ambient atmospheric temperature conditions in an adsorption step;
(b) isolating said sorbent material with adsorbed carbon dioxide in said unit from said flow-through;
(c) inducing an increase of the temperature of the sorbent material to a temperature starting the desorption of CO₂;
(d) extracting at least the desorbed gaseous carbon dioxide from the unit and separating gaseous carbon dioxide from steam in or downstream of the unit;
(e) bringing the sorbent material to ambient atmospheric temperature conditions.

14. The method according to claim 13, wherein step (c) includes injecting a stream of saturated or superheated steam by flow-through through said unit
or wherein step (b) involves isolating said sorbent material with adsorbed carbon dioxide in said unit from said flow-through while maintaining the temperature in the sorbent
or wherein step (d) involves extracting at least the desorbed gaseous carbon dioxide from the unit and separating gaseous carbon dioxide from steam by condensation in or downstream of the unit
or wherein step (c) involves inducing an increase of the temperature of the sorbent material to a temperature between 6° and 110° C., starting the desorption of CO₂.

15. The method according to claim 1, wherein it is for separating gaseous carbon dioxide from ambient atmospheric air.

16. The method according to claim 1 for separating gaseous carbon dioxide from at least one of ambient atmospheric air, flue gas and biogas

17. The method according to claim 1, wherein the non-hydrogen substituent is the same for essentially all primary and/or secondary amine moieties and is selected as methyl.

18. The method according to claim 1, wherein the sorbent material is a porous polymer material, wherein the polymer material is poly(styrene) or poly(styrene-co-divinylbenzene) based, cellulose, or an inorganic material including silica, alumina, activated carbon, and combinations thereof.

19. The method according to claim 1, wherein the sorbent material is a porous cross-linked polystyrene material in the form of poly(styrene-co-divinylbenzene), which is at least partially functionalized to or contains α-methylbenzylamine moieties, throughout the material or at least or only on its surface.

20. The method according to claim 1, wherein before and/or while carrying out the reductive amination the precursor sorbent material is swollen with an organic solvent, including with an alcoholic solvent, including ethanol.

21. The method according to claim 1, wherein the reductive amination is carried out with an ammonium salt and a cyanoborohydride salt,
wherein the ammonium salt is ammonium acetate
or wherein the cyano borohydride is sodium and/or potassium cyano borohydride.

22. The method according to claim 1, wherein the reductive amination is carried out at elevated temperature above 80° C., or at a temperature in the range of 90-140° C.

23. The method according to claim 1, wherein the reductive amination involves two steps, a first step of adding ammonium salt and a first portion of cyano borohydride salt, and a second step of adding the remaining cyano borohydride salt, wherein cyano borohydride is added in excess, and wherein the first portion makes up less than one equivalent or up to 1.5 equivalents, and the second remaining portion of cyano borohydride salt makes up another at least 1.5 or at least 2 equivalents, wherein in total more than three equivalents of cyano borohydride salt is added.

24. The method according to claim 1, wherein the sorbent material and/or the precursor sorbent material takes the form of essentially spherical beads with a particle size (D50) in the range of 0.002-4 mm, 0.005-2 mm, 0.002-1.5 mm, 0.005-1.6 mm or 0.01-1.5 mm, or in the range of 0.30-1.25 mm.
